(19) United States
(12) Patent Application Publication
(10) Pub. No.: US 2013/0137481 A1
(43) Pub. Date: May 30, 2013

(54) APPARATUS AND METHOD FOR CONTROLLING SIM CARD IN WIRELESS TERMINAL

(71) Applicant: Samsung Electronics Co., Ltd., Gyeonggi-do (KR)

(72) Inventor: Pil-Jun Kim, Seoul (KR)

(73) Assignee: Samsung Electronics Co., Ltd., Gyeonggi-do (KR)

(21) Appl. No.: 13/687,882

(22) Filed: Nov. 28, 2012

(30) Foreign Application Priority Data
Nov. 28, 2011 (CN) 10-2011-0125427

(51) Int. Cl. H04W 88/06

(52) U.S. Cl. CPC H04W 88/06
USPC 455/552.1

(57) ABSTRACT

An apparatus and method for controlling a Subscriber Identity Module (SIM) card in a wireless terminal is provided. The apparatus includes a plurality of communication units, a plurality of SIM card socket units, a switching unit and a controller. The communication units are configured to perform communication through different communication networks. The switching unit is configured to couple the communication units to the SIM card socket units. The controller is configured to control the switching unit to couple one of the communication units to one of the SIM card socket units based on a type of a SIM card inserted into the SIM card socket unit.

### CROSS-REFERENCE TO RELATED APPLICATION(S) AND CLAIM OF PRIORITY

The present application is related to and claims priority under 35 U.S.C. §119(a) to a Korean Patent Application filed in the Korean Intellectual Property Office on Nov. 28, 2011, and assigned Serial No. 10-2011-0125427, the contents of which are incorporated herein by reference.

### TECHNICAL FIELD OF THE INVENTION

The present disclosure relates generally to an apparatus and method for controlling a Subscriber Identity Module (SIM) card in a wireless terminal, and more particularly, to an apparatus and method for controlling a SIM card in a wireless terminal including a plurality of communication units, whereby the SIM card can be inserted into and used by the wireless terminal regardless of a type of the SIM card.

### BACKGROUND OF THE INVENTION

A Duos terminal having a Code Division Multiple Access (CDMA) communication unit and a Global System for Mobile communication (GSM) communication unit separately requires a Subscriber Identity Module (SIM) card for each communication unit to be inserted into a SIM card socket unit for CDMA and a SIM card socket unit for GSM included in the Duos terminal.

However, since the SIM card socket unit for CDMA and the SIM card socket unit for GSM are fixed, only a SIM card for CDMA should be inserted into the SIM card socket unit for CDMA, and only a SIM card for GSM should be inserted into the SIM card socket unit for GSM.

### SUMMARY OF THE INVENTION

To address the above-discussed deficiencies of the prior art, it is an object to provide an apparatus and method for controlling a SIM card in a wireless terminal including a plurality of communication units, whereby SIM cards can be inserted into and used by the wireless terminal regardless of the types of the SIM cards.

Another aspect of the present disclosure is to provide an apparatus and method for controlling a SIM card in a wireless terminal including a plurality of communication units, whereby a plurality of SIM cards for the same communication unit can be used by the wireless terminal.

Further another aspect of the present disclosure is to provide an apparatus and method for controlling a SIM card in a wireless terminal including a plurality of communication units, whereby a SIM card for one communication unit can be inserted into another communication unit and used by the wireless terminal regardless of a type of the SIM card.

According to one aspect of the present disclosure, there is provided an apparatus for controlling a SIM card in a wireless terminal. The apparatus includes a plurality of communication units, a plurality of SIM card socket units, a switching unit and a controller. The communication units are configured to perform communication through different communication networks. The switching unit is configured to couple the communication units to the SIM card socket units. The controller is configured to control the switching unit to couple one of the communication units to one of the SIM card socket units based on a type of a SIM card inserted into the SIM card socket unit.

According to another aspect of the present disclosure, there is provided a method of controlling a SIM card in a wireless terminal. The method includes determining a type of a SIM card inserted into one of a first SIM card socket unit and a second SIM card socket unit of the wireless terminal. The SIM card has a type corresponding to one of a first communication unit and a second communication unit in the wireless terminal. The method further includes, if a SIM card having a type corresponding to the first communication unit is inserted into the second SIM card socket unit, coupling the first communication unit to the second SIM card socket unit.

According to yet another aspect of the present disclosure, a wireless terminal is provided that includes a first communication unit, a second communication unit, a first SIM card socket unit, a switching unit and a controller. The first communication unit is configured to perform communication through a first communication network. The second communication unit is configured to perform communication through a second communication network. The switching unit is configured to couple the communication units to the first SIM card socket unit. The controller is configured, when a first SIM card is inserted into the first SIM card socket unit, to select one of the first communication unit and the second communication unit based on a type of the first SIM card and to control the switching unit to couple the selected communication unit to the first SIM card socket unit.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram of a wireless terminal according to an embodiment of the present disclosure;

FIG. 2 is a flowchart illustrating a process of using a plurality of SIM cards for the same communication unit in a wireless terminal including a plurality of communication units according to an embodiment of the present disclosure; and

FIG. 3 is a flowchart illustrating a process of using a SIM card for a communication unit by inserting the SIM card into a SIM card socket unit for another communication unit in a wireless terminal including a plurality of communication units according to an embodiment of the present disclosure.

### DETAILED DESCRIPTION OF THE INVENTION

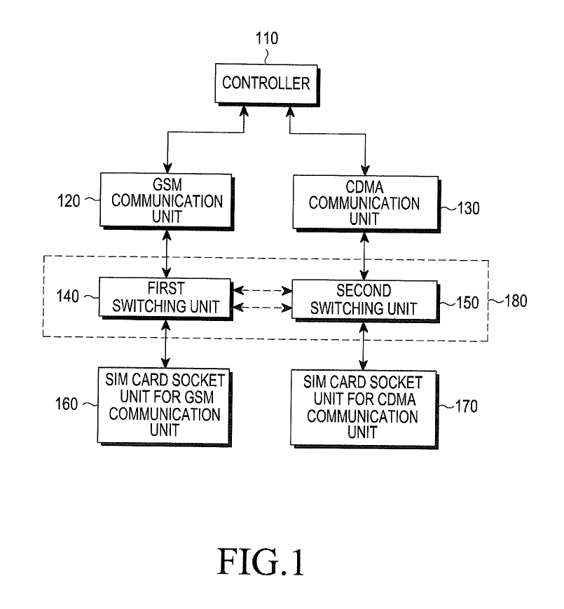

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless terminal. Preferred embodiments of the present disclosure will be described herein below with reference to the accompanying drawings. Like reference numbers are used to refer to like elements throughout the drawings.

In the embodiments of the present disclosure, the example described is that a plurality of communication units is two communication units, wherein a first communication unit is a GSM communication unit and a second communication unit is a CDMA communication unit. However, it will be understood that the plurality of communication units may comprise any suitable number of communication units and that each communication unit may comprise any suitable type of communication unit. In addition, although it is described as an example that a switching unit includes a first switching unit and a second switching unit, a communication unit may be connected to a SIM card for the communication unit inserted into a socket unit for another communication unit even through a switching operation of a single switching unit.

FIG. 1 is a block diagram of a wireless terminal according to an embodiment of the present disclosure.

Referring to FIG. 1, the wireless terminal includes a controller 110, a GSM communication unit 120 for performing communication through a GSM network, a CDMA communication unit 130 for performing communication through a CDMA network, a switching unit 180 including a first switching unit 140 and a second switching unit 150, a SIM card socket unit 160 for the GSM communication unit 120, and a SIM card socket unit 170 for the CDMA communication unit 130.

The controller 110 controls the overall operation of the wireless terminal.

According to an embodiment of the present disclosure, when a SIM card for the CDMA communication unit 130 is inserted into the SIM card socket unit 160 for the GSM communication unit 120, the controller 110 controls the first switching unit 140 and the second switching unit 150 to connect to each other so that the CDMA communication unit 130 is connected to the SIM card for the CDMA communication unit 130 inserted into the SIM card socket unit 160 for the GSM communication unit 120.

In addition, when a SIM card for the GSM communication unit 120 is inserted into the SIM card socket unit 170 for the CDMA communication unit 130, the controller 110 controls the first switching unit 140 and the second switching unit 150 to connect to each other so that the GSM communication unit 120 is connected to the SIM card for the GSM communication unit 120 inserted into the SIM card socket unit 170 for the CDMA communication unit 130.

In addition, when SIM cards for the GSM communication unit 120 are inserted into both the SIM card socket unit 160 for the GSM communication unit 120 and the SIM card socket unit 170 for the CDMA communication unit 130, the controller 110 controls the first switching unit 140 to connect the GSM communication unit 120 to the SIM card for the GSM communication unit 120 inserted into the SIM card socket unit 160 for the GSM communication unit 120 and controls the first switching unit 140 and the second switching unit 150 to connect to each other so that the GSM communication unit 120 is connected to the SIM card for the GSM communication unit 120 inserted into the SIM card socket unit 170 for the CDMA communication unit 130. In this case, the controller 110 controls the CDMA communication unit 130 to be turned off.

In addition, when the switching unit 180 is configured with a single switching unit, the controller 110 may control the switching unit 180 so that the GSM communication unit 120 is connected to a SIM card for the GSM communication unit 120 inserted into the SIM card socket unit 170 for the CDMA communication unit 130, and the CDMA communication unit 130 is connected to a SIM card for the CDMA communication unit 130 inserted into the SIM card socket unit 160 for the GSM communication unit 120.

The switching unit 180 is located between at least two communication units and at least two SIM card socket units to connect a communication unit to a SIM card for a corresponding communication unit and may include the first switching unit 140 and the second switching unit 150.

The first switching unit 140 is located between the GSM communication unit 120 and the SIM card socket unit 160 for the GSM communication unit 120, and if a SIM card for the GSM communication unit 120 is inserted into the SIM card socket unit 160 for the GSM communication unit 120, the GSM communication unit 120 is connected through the first switching unit 140 to the SIM card for the GSM communication unit 120 inserted into the SIM card socket unit 160 for the GSM communication unit 120.

Otherwise, if a SIM card for the GSM communication unit 120 is inserted into the SIM card socket unit 170 for the CDMA communication unit 130, the first switching unit 140 is connected to the second switching unit 150 so that the GSM communication unit 120 is connected to the SIM card for the GSM communication unit 120 inserted into the SIM card socket unit 170 for the CDMA communication unit 130.

The second switching unit 150 is located between the CDMA communication unit 130 and the SIM card socket unit 170 for the CDMA communication unit 130, and if a SIM card for the CDMA communication unit 130 is inserted into the SIM card socket unit 170 for the CDMA communication unit 130, the CDMA communication unit 130 is connected through the second switching unit 150 to the SIM card for the CDMA communication unit 130 inserted into the SIM card socket unit 170 for the CDMA communication unit 130.

Otherwise, if a SIM card for the CDMA communication unit 130 is inserted into the SIM card socket unit 160 for the GSM communication unit 120, the second switching unit 150 is connected to the first switching unit 140 so that the CDMA communication unit 130 is connected to the SIM card for the CDMA communication unit 130 inserted into the SIM card socket unit 160 for the GSM communication unit 120.

In addition, when the switching unit 180 is configured with a single switching unit, the switching unit 180 may connect the GSM communication unit 120 to a SIM card for the GSM communication unit 120 inserted into the SIM card socket unit 170 for the CDMA communication unit 130 and connect the CDMA communication unit 130 to a SIM card for the CDMA communication unit 130 inserted into the SIM card socket unit 160 for the GSM communication unit 120.

A SIM card for the GSM communication unit 120 or a SIM card for the CDMA communication unit 130 is inserted into the SIM card socket unit 160 for the GSM communication unit 120.

A SIM card for the CDMA communication unit 130 or a SIM card for the GSM communication unit 120 is inserted into the SIM card socket unit 170 for the CDMA communication unit 130.

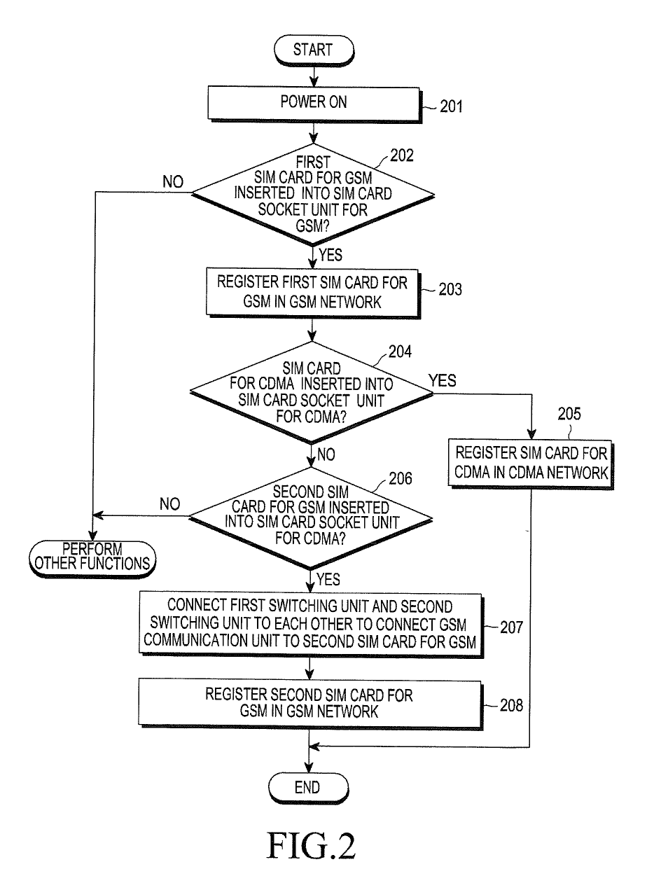

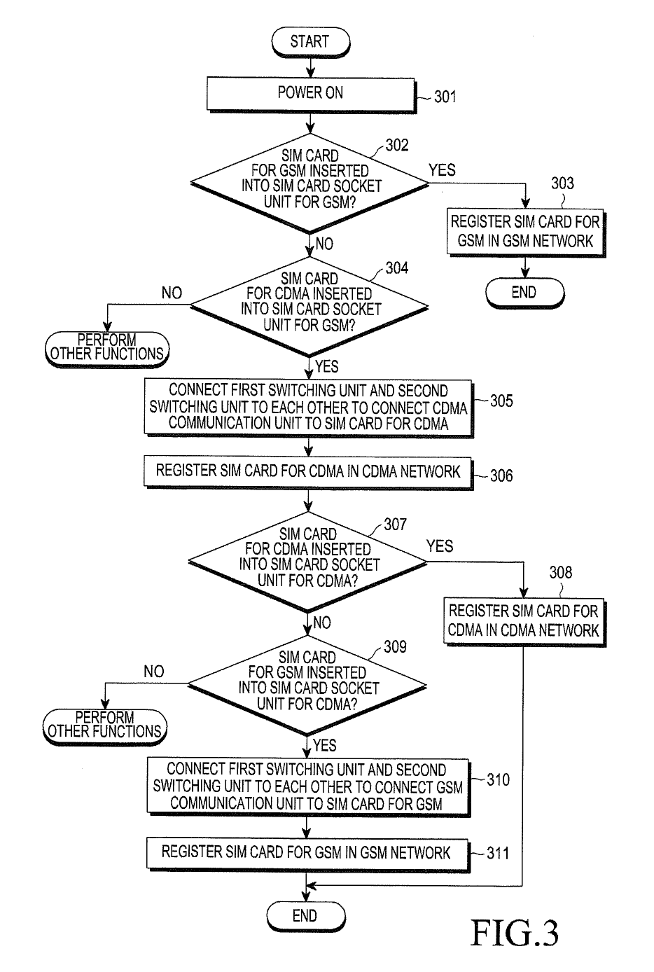

An operation of controlling a SIM card in the wireless terminal is described in detail with reference to FIGS. 2 and 3.

FIG. 2 is a flowchart illustrating a process of using a plurality of SIM cards for the same communication unit in a wireless terminal including a plurality of communication units according to an embodiment of the present disclosure.

Hereinafter, this embodiment is described in detail with reference to FIG. 1.

Referring to FIG. 2, in step 201, the wireless terminal is turned on. In step 202, the controller 110 determines whether a first SIM card for GSM is inserted into the SIM card socket unit 160 for GSM. If the first SIM card for GSM is inserted into the SIM card socket unit 160 for GSM, the controller 110 proceeds to step 203 and registers the first SIM card for GSM inserted into the SIM card socket unit 160 for GSM in a GSM network.

In step 204, the controller 110 determines whether a SIM card for CDMA is inserted into the SIM card socket unit 170 for CDMA. If the SIM card for CDMA is inserted into the SIM card socket unit 170 for CDMA, the controller 110 proceeds to step 205 and registers the SIM card for CDMA in a CDMA network.

However, if the controller 110 detects that a second SIM card for GSM is inserted into the SIM card socket unit 170 for CDMA in step 206, the controller 110 proceeds to step 207 and controls the first switching unit 140 and the second switching unit 150 to connect to each other so that the GSM communication unit 120 is connected to the second SIM card for GSM inserted into the SIM card socket unit 170 for CDMA. In step 208, the controller 110 controls the second SIM card for GSM inserted into the SIM card socket unit 170 for CDMA to be registered in the GSM network.

At this time, the controller 110 controls the CDMA communication unit 130 to be turned off to prevent current consumption.

By the process of FIG. 2, the SIM cards for GSM may operate as dual SIM cards for GSM by being inserted into the SIM card socket unit 160 for GSM and the SIM card socket unit 170 for CDMA in the wireless terminal including the GSM communication unit 120 and the CDMA communication unit 130.

FIG. 3 is a flowchart illustrating a process of using a SIM card for a communication unit by inserting the SIM card into a SIM card socket unit for another communication unit in a wireless terminal including a plurality of communication units according to an embodiment of the present disclosure.

Hereinafter, this embodiment is described in detail with reference to FIG. 1.

Referring to FIG. 3, in step 301, the wireless terminal is turned on. In step 302, the controller 110 determines whether a SIM card for GSM is inserted into the SIM card socket unit 160 for GSM. If the SIM card for GSM is inserted into the SIM card socket unit 160 for GSM, the controller proceeds to step 303 and registers the SIM card for GSM inserted into the SIM card socket unit 160 for GSM in a GSM network.

However, if the controller 110 detects that a SIM card for CDMA instead of the SIM card for GSM is inserted into the SIM card socket unit 160 for GSM in step 304, the controller 110 proceeds to step 305 and controls the first switching unit 140 and the second switching unit 150 to connect to each other so that the CDMA communication unit 130 is connected to the SIM card for CDMA inserted into the SIM card socket unit 160 for GSM. In step 306, the controller 110 controls the SIM card for CDMA inserted into the SIM card socket unit 160 for GSM to be registered in a CDMA network.

In step 307, the controller 110 determines whether a SIM card for CDMA is inserted into the SIM card socket unit 170 for CDMA. If the SIM card for CDMA is inserted into the SIM card socket unit 170 for CDMA, the controller 110 proceeds to step 308 and registers the SIM card for CDMA inserted into the SIM card socket unit 170 for CDMA in the CDMA network.

However, if the controller 110 detects that a SIM card for GSM instead of the SIM card for CDMA is inserted into the SIM card socket unit 170 for CDMA in step 309, the controller 110 proceeds to step 310 and controls the first switching unit 140 and the second switching unit 150 to connect to each other so that the GSM communication unit 120 is connected to the SIM card for GSM inserted into the SIM card socket unit 170 for CDMA. In step 311, the controller 110 controls the SIM card for GSM inserted into the SIM card socket unit 170 for CDMA to be registered in the GSM network.

By the process of FIG. 3, even if a SIM card for CDMA is inserted into the SIM card socket unit 160 for GSM and a SIM card for GSM is inserted into the SIM card socket unit 170 for CDMA in the wireless terminal including the GSM communication unit 120 and the CDMA communication unit 130, the SIM cards may operate by being connected to the corresponding communication network.

As is apparent from the foregoing description, the proposed apparatus and method for controlling a SIM card in a wireless terminal including a plurality of communication units allow a user to use a plurality of SIM cards for the same communication unit in the wireless terminal and use a SIM card for a communication unit by inserting the SIM card into a SIM card socket unit for another communication unit regardless of the types of the SIM cards.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus for controlling a Subscriber Identity Module (SIM) card in a wireless terminal, comprising:
a plurality of communication units configured to perform communication through different communication networks;
a plurality of SIM card socket units;
a switching unit configured to couple the communication units to the SIM card socket units; and
a controller configured to control the switching unit to couple one of the communication units to one of the SIM card socket units based on a type of a SIM card inserted into the SIM card socket unit.

2. The apparatus of claim 1, wherein the communication units comprise a first communication unit and a second communication unit and the SIM card socket units comprise a first SIM card socket unit and a second SIM card socket unit, and wherein:
the first communication unit is configured to perform communication through a first communication network;
the second communication unit is configured to perform communication through a second communication network;
the first SIM card socket unit corresponds to the first communication unit;
the second SIM card socket unit corresponds to the second communication unit; and
the controller is configured to control the switching unit to couple the first communication unit to the second SIM card socket unit when a SIM card for the first communication unit is inserted into the second SIM card socket unit and to control the switching unit to couple the second communication unit to the first SIM card socket unit when a SIM card for the second communication unit is inserted into the first SIM card socket unit.

3. The apparatus of claim 2, wherein the controller is further configured to control the switching unit to couple the first communication unit to the first SIM card socket unit and the second SIM card socket unit when a SIM card for the first communication unit is inserted into the first SIM card socket unit and a SIM card for the first communication unit is inserted into the second SIM card socket unit.

4. The apparatus of claim 3, wherein the controller is further configured to turn off the second communication unit when the SIM cards for the first communication unit are inserted into the first SIM card socket unit and the second SIM card socket unit.

5. The apparatus of claim 1, wherein the switching unit comprises at least two switching units.

6. The apparatus of claim 1, wherein, when the switching unit comprises a first switching unit and a second switching unit, the first switching unit is located between the first communication unit and the first SIM card socket unit and the second switching unit is located between the second communication unit and the second SIM card socket unit.

7. The apparatus of claim 1, wherein the communication units comprise a Global System for Mobile communication (GSM) communication unit and a Code Division Multiple Access (CDMA) communication unit.

8. The apparatus of claim 1, wherein the controller is further configured, when the SIM card is inserted into the SIM card socket unit, to determine the type of the SIM card.

9. A method of controlling a SIM card in a wireless terminal, comprising:
determining a type of a SIM card inserted into one of a first SIM card socket unit and a second SIM card socket unit of the wireless terminal, wherein the SIM card has a type corresponding to one of a first communication unit and a second communication unit in the wireless terminal; and
if a SIM card having a type corresponding to the first communication unit is inserted into the second SIM card socket unit, coupling the first communication unit to the second SIM card socket unit.

10. The method of claim 9, further comprising:
if a SIM card having a type corresponding to the second communication unit is inserted into the first SIM card socket unit, coupling the second communication unit to the first SIM card socket unit.

11. The method of claim 9, further comprising:
if a SIM card having a type corresponding to the first communication unit is inserted into the first SIM card socket unit, coupling the first communication unit to the first SIM card socket unit.

12. The method of claim 11, further comprising, when the first communication unit is coupled to the first SIM card socket unit and to the second SIM card socket unit, turning off the second communication unit.

13. The method of claim 9, wherein the first communication unit comprises a Global System for Mobile communication (GSM) communication unit and the second communication unit comprises a Code Division Multiple Access (CDMA) communication unit.

14. A wireless terminal, comprising:
a first communication unit configured to perform communication through a first communication network;
a second communication unit configured to perform communication through a second communication network;
a first SIM card socket unit;
a switching unit configured to couple one of the communication units to the first SIM card socket unit; and
a controller configured, when a first SIM card is inserted into the first SIM card socket unit, to select one of the first communication unit and the second communication unit based on a type of the first SIM card and to control the switching unit to couple the selected communication unit to the first SIM card socket unit.

15. The wireless terminal of claim 14, further comprising a second SIM card socket unit, wherein the switching unit is further configured to couple one of the communication units to the second SIM card socket unit, and wherein the controller is further configured, when a second SIM card is inserted into the second SIM card socket unit, to select one of the first communication unit and the second communication unit based on a type of the second SIM card and to control the switching unit to couple the selected communication unit to the second SIM card socket unit.

16. The wireless terminal of claim 15, wherein the controller is further configured to turn off the second communication unit when the first communication unit is coupled to the first SIM card socket unit and to the second SIM card socket unit.

17. The wireless terminal of claim 15, wherein the switching unit comprises at least two switching units.

18. The wireless terminal of claim 15, wherein the switching unit comprises:
a first switching unit located between the first communication unit and the first SIM card socket unit; and
a second switching unit located between the second communication unit and the second SIM card socket unit.

19. The wireless terminal of claim 14, wherein the first communication unit comprises a Global System for Mobile communication (GSM) communication unit and the second communication unit comprises a Code Division Multiple Access (CDMA) communication unit.

20. The wireless terminal of claim 14, wherein the controller is further configured, when the first SIM card is inserted into the first SIM card socket unit, to determine the type of the first SIM card.
